(19) United States
(12) Patent Application Publication
(10) Pub. No.: US 2006/0252461 A1
(43) Pub. Date: Nov. 9, 2006

(54) Controlling wireless communications from a multi-sector antenna of a base station

(76) Inventors: Neil Gordon Grant, Swindon (GB); Christopher David Scarisbrick, Swindon (GB); Stephen Cooper, Leighton Buzzard (GB)

Correspondence Address: WILLIAMS, MORGAN & AMERSON, 10333 RICHMOND, SUITE 1100, HOUSTON, TX, 77042, US

(21) Appl. No.: 11/123,422

(22) Filed: May 6, 2005

(51) Int. Cl. H04M 1/00

(52) U.S. Cl. 455/562.1

(57) ABSTRACT

The present invention provides a communication node associated with a wireless network to communicate with a mobile device over a wireless medium across a plurality of mobile communication regions. The communication node comprises an antenna arrangement including a first, a second and a third antenna, wherein the first antenna is primarily associated with a first service coverage area of a first mobile communication region of the plurality of mobile communication regions, the second antenna is primarily associated with a second service coverage area of the first mobile communication region, and the third antenna is primarily associated with a third service coverage area of the first mobile communication region for combining diversity from the first, second and third antennas to fully communicate information to and from at least one of the first, second and third service coverage areas and to partially communicate information to and from at least two of the first, second and third service coverage areas. In one embodiment, a method may adapt a first, a second and a third antenna in a multi-sector antenna arrangement of a base station across cells by combining diversity from the first, second, and third antennas. Such antenna arrangement may reduce installation and alignment costs for a multi-sector antenna while increasing a receive sensitivity and decreasing a transmit power requirement because base station antennas are not deployed in diversity pairs rather are equally distributed.

### BACKGROUND OF THE INVENTION

1. Field of the Invention

This invention relates generally to telecommunications, and more particularly, to wireless communications.

2. Description of the Related Art

In a telecommunication system, a large geographically distributed network coverage area is typically partitioned into a multiplicity of mobile communication regions, such as cells, where each cell includes a communication node, such as a base station to realize wireless communications with one or more mobile stations or wireless devices within that cell. The network coverage area is commonly based on wireless links that are designed to operate at a minimum level consistent with Quality of Service (QoS) in an area where the mobile station has sufficient power to achieve a target signal-to-noise (SNR) ratio at a cell site that includes the base station.

Continued growth in the number of users of mobile communications means that many wireless network operators or service providers must find new ways of increasing the capacity of their networks. Their primary options include allocating more frequency, introducing frequency-hopping techniques, and adding micro-cells and new antenna systems. Antenna systems represent an area in which considerable development efforts and field trials are being conducted to increase capacity in mobile communication networks.

Specifically, many traditional installations of mobile communication base-station antennas make use of space-diversity techniques, which require at least two antennas pointing in the same direction and separated from each other. Alternatively, polarization diversity reduces antenna visibility. Polarization diversity increases gain through the simultaneous reception of two orthogonally polarized signals from a single, dual-polarized antenna. Regardless of the diversity, in general, a cell site may include sector antennas oriented in different directions. In each direction, one or more transmit antennas and receive antennas may be provided.

However, the radio frequency (RF) propagation environment usually provides multiple opportunities for the transmit and receive signals to be reflected, causing undesired signal strength variations at both the base station and the mobile station. These affects contribute to a reduction in the service coverage area. To this end, cellular base stations often employ receive diversity to improve the receive sensitivity. A second (diversity) receive antenna pointing in the same direction as the first (main) receive antenna, allows the base station to select the best receive signal, or combine the two signals, to achieve better receive sensitivity than possible with a single receive antenna. If the signal received by one antenna is in a null due to multi-path fading (addition and subtraction of multiple reflected signals), there is a strong likelihood that the other antenna is still receiving a good signal. Likewise, transmit diversity takes many forms. In its simplest form, using two transmit antennas allows separate transmit signals to be sent up each antenna. This allows a cost saving in the development of smaller filters and power amplifiers.

FIG. 8A illustrates a conventional three-sector antenna arrangement 800 with diversity pairs for serving each sector from a cellular base station. For example, in a tri-sector CDMA base station, a receiver optimally combines the signals from two receive chains (a and b), to achieve a high signal-to-noise ratio (SNR) and a low bit error rate (BER), implementation a receive diversity utilizing two antenna's per sector. Likewise, different transmit signals can use the main and diversity antenna in a single sector. Each pair of transmit signals (half a pair, per antenna) implements a transmit diversity, utilizing two antenna's per sector. Thus, the tri-sector CDMA base station may utilize two antennas per sector, with a nominal beamwidth of 120° per sector. The two antennas (per sector), may either be: spaced some distance apart from one another (spatial diversity); or enclosed in a single radome, employing +45/−45 degree polarization diversity. In either case, the antennas may be designed to keep the majority of their coverage within the nominal 120° beamwidth of their sector. To cover three sectors, for example, six antennas, six co-axial feeders (from the antenna's to the base station) and six receive chains may be required. Three or six transmit chains may also be required.

Accordingly, the tri-sector base station employs six antenna's (and associated co-axial feeders) of 120° nominal beamwidth, deployed in diversity pairs. The boresight direction of each antenna pair is offset by 120° from the previous antenna pair, leading to three antenna pairs of 120° beamwidth, arranged in a circular pattern (boresight: 0°, 0°, 120°, 120°, 240°, 240°). However, the tri-sector base station employs a diversity antenna pair that both cover 300° to 60°. Therefore, such a multi-sector antenna for a base station does not offer an optimal performance for the amount of hardware used in a mobile communication system.

The present invention is directed to overcoming, or at least reducing, the effects of, one or more of the problems set forth above.

### SUMMARY OF THE INVENTION

In one embodiment of the present invention, a communication node associated with a wireless network is provided to communicate with a mobile device over a wireless medium across a plurality of mobile communication regions. The communication node comprises an antenna arrangement including a first, a second and a third antenna, wherein the first antenna is primarily associated with a first service coverage area of a first mobile communication region of the plurality of mobile communication regions, the second antenna is primarily associated with a second service coverage area of the first mobile communication region, and the third antenna is primarily associated with a third service coverage area of the first mobile communication region for combining diversity from the first, second and third antennas to fully communicate information to and from at least one of the first, second and third service coverage areas and to partially communicate information to and from at least two of the first, second and third service coverage areas.

In another embodiment, a base station associated with a plurality of cells is provided for transmitting and receiving communication information to and from a mobile device, each cell being divided into a plurality of sectors. The base station comprises a multi-sector antenna arrangement including a first, a second and a third antenna, wherein for combining diversity from the first, second and third antennas the first antenna is configured to provide a full coverage in a first sector of the cell of the plurality of cells and the second and third antennas are configured to provide a partial coverage in at least one of a second and a third sector of the cell of the plurality of cells such that the base station adapts the first antenna to radiate a first beam in the first sector of the cell to provide the full coverage in the first sector and adapts the second and third antennas to radiate a second and a third beam, respectively, that provide the partial coverage in the second and third sectors of the cell.

In yet another embodiment, a digital cellular network comprises a plurality of cells to communicate with a mobile device over a wireless medium, wherein at least one of the plurality of cells to include a base transceiver station having a base station for transmitting and receiving communication information. The base station includes a multi-sector antenna arrangement including a first, a second and a third antenna, wherein for combining diversity from the first, second and third antennas the first antenna is configured to provide a full coverage in a first sector of the cell of the plurality of cells and the second and third antennas are configured to provide a partial coverage in at least one of a second and a third sector of the cell of the plurality of cells such that the base station adapts the first antenna to radiate a first beam in the first sector of the cell to provide the full coverage in the first sector and adapts the second and third antennas to radiate a second and a third beam, respectively, that provide the partial coverage in the second and third sectors of the cell.

In still another embodiment, a telecommunication system comprises a communication node associated with a wireless network to communicate with a mobile device over a wireless medium across a plurality of mobile communication regions. The communication node includes an antenna arrangement including a first, a second and a third antenna, wherein the first antenna is primarily associated with a first service coverage area of a first mobile communication region of the plurality of mobile communication regions, the second antenna is primarily associated with a second service coverage area of the first mobile communication region, and the third antenna is primarily associated with a third service coverage area of the first mobile communication region for combining diversity from the first, second and third antennas to fully communicate information to and from at least one of the first, second and third service coverage areas and to partially communicate information to and from at least two of the first, second and third service coverage areas.

In a further embodiment of the present invention, a method is provided for adapting a plurality of antennas of a communication node associated with a wireless network across a plurality of mobile communication regions to communicate with a mobile device over a wireless medium. The method comprises distributing a first, a second and a third antenna of the plurality of antennas in a circular pattern to provide coverage across a first, a second and third service coverage areas of a first mobile communication region of the plurality of mobile communication regions, associating the first antenna primarily with the first service coverage area of the first mobile communication region, associating the second antenna primarily with the second service coverage area of the first mobile communication region, associating the third antenna primarily with the third service coverage area of the first mobile communication region and combining diversity from the first, second and third antennas to fully communicate information to and from at least one of the first, second and third service coverage areas and to partially communicate information to and from at least two of the first, second and third service coverage areas.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a telecommunication system that controls wireless communications from a base station with a multi-sector antenna to a mobile device according to one illustrative embodiment of the present invention;

FIG. 2 illustrates an antenna arrangement for the multi-sector antenna shown in FIG. 1 for a communication node, such as a base transceiver station (BTS, e.g., node-B) optimized for use with antennas that cover either one or more adjacent sectors or multiple sectors to provide an improved coverage in accordance with one illustrative embodiment of the present invention;

FIG. 3 illustrates a six-sector CDMA cellular base station showing receive paths for sectors 1-3 while utilizing adjacent sector received paths for a receive diversity and a beam forming in accordance with one illustrative embodiment of the present invention;

FIG. 4 illustrates a six-sector CDMA cellular base station showing transmit paths for sectors 1-3 while utilizing adjacent sector transmit paths for a transmit diversity and a beam forming in accordance with one illustrative embodiment of the present invention;

FIG. 5 illustrates a six-sector CDMA cellular base station showing receive paths while utilizing all sector receive paths for a received diversity and a beam forming in accordance with one illustrative embodiment of the present invention;

FIG. 6 illustrates a six-sector CDMA cellular base station showing transmit paths while utilizing all sector transmit paths for a transmit diversity and a beam forming according to one embodiment of the present invention;

FIG. 7 illustrates a six-sector CDMA cellular base station with a remote radio frequency unit in accordance with one illustrative embodiment of the present invention;

FIG. 8A illustrates a conventional three-sector antenna arrangement with diversity pairs for serving each sector from a cellular base station;

FIG. 8B illustrates a six-sector antenna in a single radome for use in the cellular base stations shown in FIGS. 3-7 according to one embodiment of the present invention;

FIG. 8C illustrates a four-sector antenna in a single radome for use in the cellular base stations shown in FIGS. 3-7 in accordance with one embodiment of the present invention;

FIG. 8D illustrates an eight-sector antenna in a single radome for use in the cellular base stations shown in FIGS. 3-7 in accordance with one embodiment of the present invention;

FIG. 9 illustrates a stylized representation of a method for adapting a plurality of antennas of the communication node shown in FIG. 1 associated with a wireless network across a plurality of mobile communication regions to communicate with a mobile device over a wireless medium in accordance with one illustrative embodiment of the present invention;

FIG. 10A illustrates a stylized representation of a method that uses a receiver chain and a transmitter chain shown in FIG. 2 of adjacent service coverage areas of a first mobile communication region for each antenna of a plurality of antennas to provide a receive diversity, a transmit diversity and a beam forming in a mobile communication with a mobile device according to one illustrative embodiment of the present invention; and

FIG. 10B illustrates a stylized representation of a method that uses a receiver chain and a transmitter chain shown in FIG. 2 of all service coverage areas of a first mobile communication region for each antenna of a plurality of antennas to provide a receive diversity, a transmit diversity and a beam forming in a mobile communication with a mobile device according to one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Generally, a base station includes an antenna arrangement that transmits and receives information from a plurality of mobile devices, e.g., cellular phones, in a cell. The cell may be divided into multiple sectors. The antenna arrangement includes a set of antennas, each of which may be used to serve one or more of the multiple sectors in the cell. The reception of a receive signal and transmission of a transmit signal to and from an antenna to a sector is coordinated with receptions and transmissions of the receive and transmit signals, respectively, to and from other antennas to their corresponding sectors. In this manner, the base station may be optimized for use with an antenna that covers either the adjacent sectors or all sectors, providing an improved coverage for a cellular network in a telecommunication system.

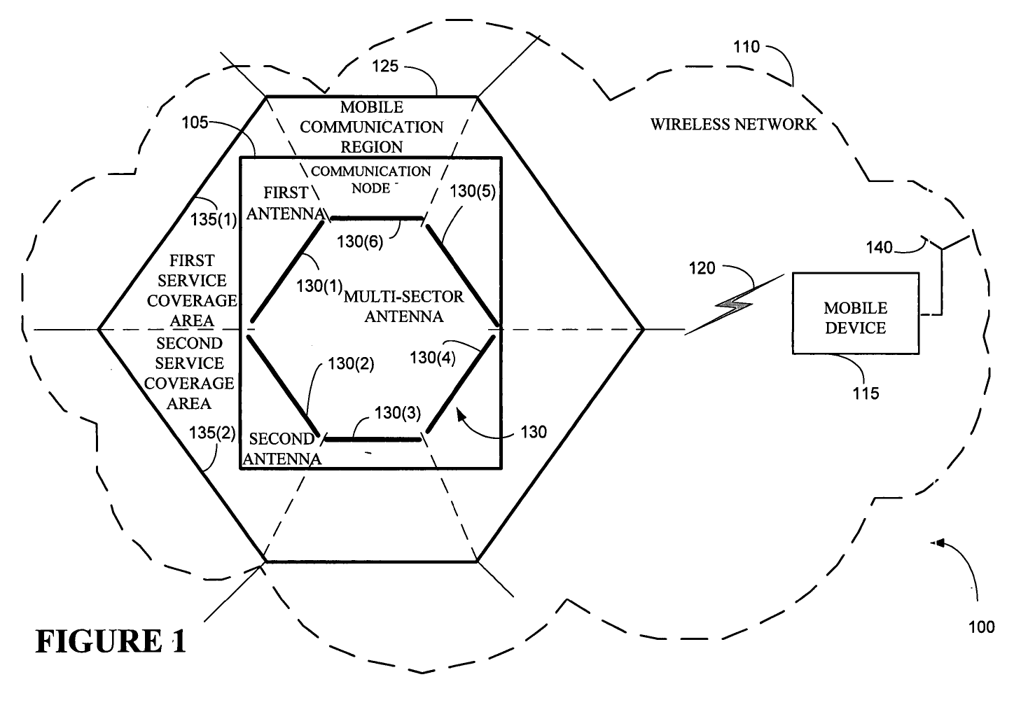

Referring to FIG. 1, a telecommunication system 100 is illustrated to include a communication node 105 associated with a wireless network 110 to communicate with a mobile device 115 over a wireless medium 120 across a plurality of mobile communication regions including a first mobile communication region 125 in accordance with one embodiment of the present invention. Examples of the telecommunication system 100 include a time division multiple access (TDMA) mobile communication system, a global system of mobile communications (GSM) and a code division multiple access (CDMA) mobile communication system.

The communication node 105 may comprise a multi-sector antenna 130 with an antenna arrangement including a plurality of antennas having a first antenna 130(1) and a second antenna 130(2). The first and second antennas 130(1-2) may be configured to communicate information to and from at least one of a first service coverage area 135(1) and a second service coverage area 135(2) of the first mobile communication region 125. The communication node 105 may adapt the first antenna 130(1) to keep a majority of communication coverage within the first service coverage area 135(1) and adapt the second antenna 135(2) to communicate over at least a portion of the second service coverage area 135(2) of the first mobile communication region 125.

An example of the telecommunication system 100 includes a conventional mobile communication system including a base station having a base station antenna that wirelessly transmits a signal to a mobile station, such as the mobile device 115 having an antenna 140. An example of the wireless network 110 includes a communications network including a base station and two or more distributed cells, which may be remotely located from the base station. These cells may be coupled to the base station by transmission mediums, which may be, for example, be cable, fiber, and/or air interface.

In one embodiment, the wireless network 110 may be a cellular communications network including a number of spaced apart base stations, each station including a multi-sector antenna located on a tower or other structure at the base station. The base station with the multi-sector antenna 130 may form a cell site, and the antennas of the multi-sector antenna 130 may separate a surrounding network coverage area into sectors. For example, each cell site may form three sectors. A cellular user may communicate with a base station via the antennas of the multi-sector antenna 130 and a mobile user may be “handed off” while moving from one sector to another or from the jurisdiction of one base station to another.

The multi-sector antenna 130 may comprise an antenna configuration in which the plurality of antennas may be arranged in a circular pattern and the wireless mobile device 115 may not be confined to any particular service coverage area of the first and second service coverage areas 135(1-2), in accordance with one embodiment of the present invention. For example, the multi-sector antenna 130 may be a six-sector base station antenna, in which each sector antenna may have a horizontal beamwidth equal to or less than 60 degrees where the horizontal beamwidth may be an angle, measured in a horizontal plane, between the directions at which the intensity of an electromagnetic antenna beam is one-half its maximum value. Likewise, a first sector may be defined by the first service coverage area 135(1) and a second sector may be defined by the second service coverage area 135(2), in accordance with one embodiment of the present invention. That is, the first and second service coverage areas 135(1-2) may form two antenna sectors of a six-sector base station antenna for the multi-sector antenna 130.

As illustrated in FIG. 1, the telecommunication system 100 may include a plurality of communication nodes, i.e., a plurality of base stations that wirelessly transmit and receive wireless communication signals to/from the mobile device 115. Each of the base stations may cover respective sectors. A mobile switching center (MSC) may be connected to the plurality of base stations via communication lines and may be further coupled to a public switched telephone network (PSTN) to enable communication between the mobile device 115 and another party on the PSTN.

A wireless communication signal received at the mobile device 115 may be demodulated in accordance with an associated modulation scheme used at the communication node 105. For instance, a differential quadrature phase shift keying (DQPSK), a Gaussian minimum shift keying (GMSK), or a quadrature phase-shift keying (QPSK) demodulation may be carried out at the mobile device 115 for TDMA, GSM, and CDMA systems, respectively. The wireless communication signal may be further processed in a conventional manner to provide a signal OUT, which may be data or voice.

At the communication node 105, the antenna arrangement of the multi-sector antenna 130 may transmit or receive information to/from the mobile device 115 within the first mobile communication region 125, such as a cell. For example, the cell may be divided into sectors, such that each antenna of the multi-sector antenna 130 may be selectively used to serve one or more of the sectors, i.e., the service coverage areas 135, including the first and second service coverage areas 135(1-2).

In one embodiment, the plurality of antenna of the multi-sector antenna 130 may radiate a sector beam covering the cell, i.e., the first mobile communication region 125. For example, the first antenna 130(1) may radiate a majority of a first beam in the first sector of the cell and adapt the second antenna 130(2) of the plurality of antennas of the multi-sector antenna 130 to radiate a second beam that covers at least a portion of the second sector of the cell. According to one embodiment, the first sector may be adjacent to the second sector.

In one particular illustrative embodiment, as shown in FIG. 1, the multi-sector antenna 130 may comprise “m” antennas, which are structurally identical and the mobile communication region 125, i.e., the cell, is equally divided into m sectors, i.e., the service coverage areas. As one example, the antennas 130(1-6) may be arranged in a hexagonal format indicated by the hexagonal shape of the multi-sector antenna 130 with each side thereof representing one of such antennas. Each sector of the service coverage may be covered by an antenna beam generated by the associated antenna.

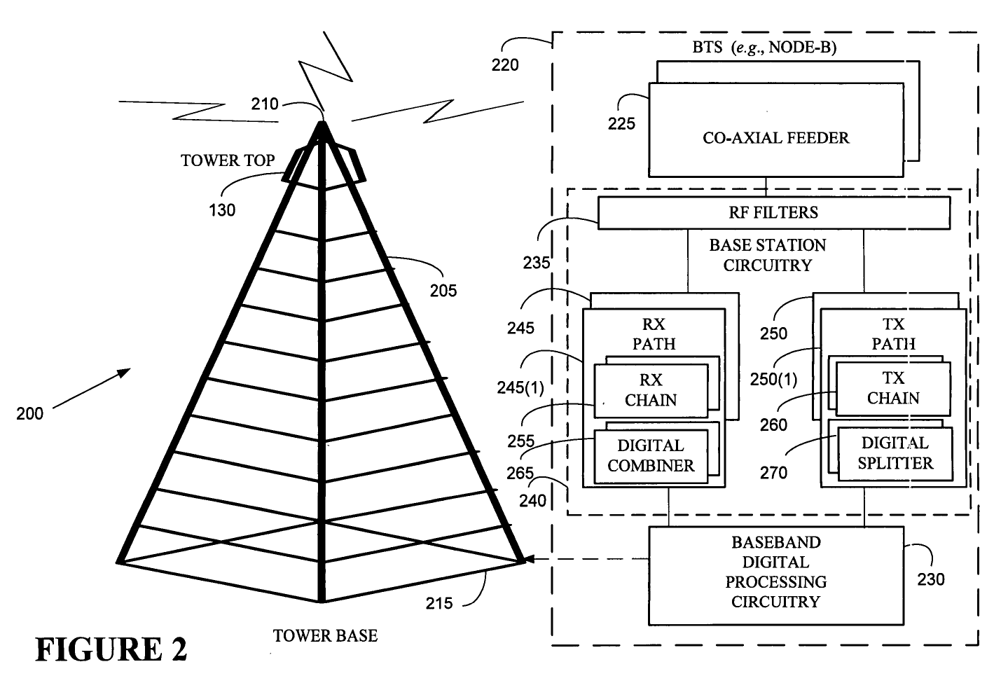

Referring to FIG. 2, an antenna configuration 200 for the antenna arrangement of the multi-sector antenna 130 shown in FIG. 1 includes a tower 205 with a tower top 210 and a tower base 215 for the plurality of antennas associated with the communication node 105, e.g., a base transceiver station (BTS, e.g., node-B) 220 according to one illustrative embodiment of the present invention. The antenna configuration 200 further comprises a plurality of co-axial feeders 225 associated with the plurality of antennas 130(1-6) of the multi-sector antenna 130 shown in the antenna configuration 200 and coupled to the tower top 210 and baseband digital processing circuitry 230 disposed at the tower base 215. It should be noted that the baseband digital processing circuitry 230 may reside at either the base transceiver station 220 or at the tower top 210. However, for the sake of convenience, the baseband digital processing circuitry 230 is shown to be located within the base transceiver station 220 in FIG. 2.

Besides the plurality of co-axial feeders 225, the base transceiver station 220 may include base station circuitry 240 coupled to the baseband digital processing circuitry 230. The base station circuitry 240 may include a multiplicity of radio frequency (RF) filters 235 for normal filtering, a plurality of receiver (RX) paths 245 to receive a signal from the plurality of antennas of the multi-sector antenna 130 and a plurality of transmitter (TX) paths 250 to transmit a signal from the plurality of antennas of the multi-sector antenna 130.

For example, the first antenna 130(1) shown in FIG. 1 may receive a first signal from the mobile device 115 and the second antenna 130(2) may receive a second signal therefrom. While a receiver path 245(1) may include a receiver (RX) chain 255 for each antenna of the plurality of antennas 130(1-6), a transmit path 250(1) may include a transmitter (TX) chain 260 for each antenna of the plurality of antennas 130(1-6).

In one embodiment, the base station circuitry 240 may adapt the receiver chains 255 of adjacent service coverage areas, such as the first and second service coverage areas 135(1-2), as shown in FIG. 1, of the first mobile communication region 125 in order to provide a receive diversity and a beam forming in a mobile communication with the mobile device 115. Similarly, the transmitter chains 260 of adjacent service coverage areas of the first mobile communication region 125 may provide a transmit diversity and a beam forming in a mobile communication with the mobile device 115.

Alternatively, in another embodiment, the receiver chains 255 may be adapted by the base station circuitry 240 so that all service coverage areas 135 of the first mobile communication region 125 may provide a receive diversity and a beam forming in a mobile communication with the mobile device 115. Likewise, the base station circuitry 240 may adapt the transmitter chains 260 so that all service coverage areas 135 of the first mobile communication region 125 may provide a transmit diversity and a beam forming in a mobile communication with the mobile device 115.

The base station circuitry 240 for the receiver path 245 may provide a digital combiner 265 that combines receive signals, for example, from the first and second antennas 130(1-2) covering the first and second service coverage areas 135(1-2), respectively, into a single receive signal. Similarly, the transmitter path 250 may include a digital splitter 270 to split a transmit signal between the first and second antennas 130(1-2) covering the first and second service coverage areas 135(1-2), respectively.

Consistent with one embodiment, the combiner 265 may combine receive signals from the first and second antennas 130(1-2) covering a first and a second sector of a cell, respectively. Likewise, the splitter 270 may split a single transmit signal between the first and second antennas 130(1-2) covering the first and second sectors of the cell, respectively. The first and second antennas 130(1-2) may provide a coverage within a nominal beamwidth across the first and second sectors of the cell. The nominal beamwidth may be a useful radiation angle in a frequency range of interest for the first and second antennas 130(1-2) across the first and second sectors of the cell. To this end, the base transceiver station 220 may configure each of the first and second antennas 130(1-2) to communicate information to and from at least one of the first and second sectors of the cell of the plurality of cells such that the first antenna 130(1) may radiate a majority of a first beam in the first sector of the cell and the second antenna 130(2) may radiate a second beam that covers at least a portion of the second sector of the cell.

Pursuant to one exemplary embodiment, the base transceiver station 220 may be provided within a digital cellular network comprising a plurality of cells to communicate with the mobile device 115 over the wireless medium 120. The base transceiver station 220 may transmit and receive communication information to/from the mobile device 115, wherein the base transceiver station 220 may be defined at least in part by a code division multiple access (CDMA) protocol and the multi-sector antenna 130 may be disposed in a single radome. The base transceiver station 220 may further comprise modulation and de-modulation circuitry (not shown) that increases a receive sensitivity and decreases a transmit power requirement of the base transceiver station 220 while using the multi-sector antenna 130 for a receive diversity, a transmit diversity and a beam forming in a mobile communication with the mobile device 115.

As shown in FIG. 2, the base transceiver station 220 may perform call administration, and establish and maintain telephone or cellular connections between mobile stations or wireless devices, such as the mobile device 115 in the corresponding mobile communication region or the cell via a wireline network, e.g., a public switched telephone network (PSTN). Within the cell, the base transceiver station 220 may wirelessly receive communication information from the mobile device 115 and transmit back wirelessly communication information to the mobile device 115. In a code division multiple access (CDMA) wireless mobile communication system, for example, the base transceiver station 220 identifies an individual mobile station, i.e., the mobile device 115 by de-spreading the pseudo-noise signature codes and information data is extracted by demodulation. The cell may be divided into a plurality of service coverage areas or sectors, such as “n.” Each sector may cover a service coverage area of an angular span of 2Π/n radians of the cell.

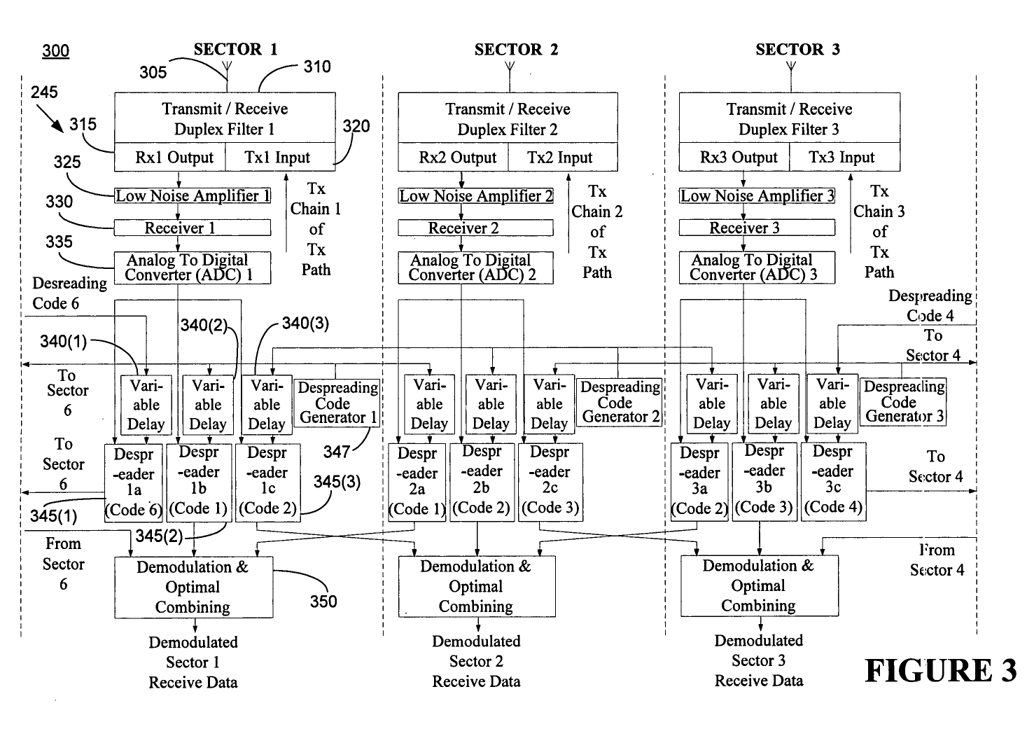

Referring to FIG. 3, a six-sector CDMA cellular base station with receive paths 300 is shown including the receive path 245 of FIG. 2 such that the adjacent sector receive paths may be utilized for a receive diversity and a beam forming in a mobile communication with mobile device 115 according to one illustrative embodiment of the present invention. The sector 1 antenna 305 includes a transmit/receive duplex filter 1, 310, coupled with a receive 1 (RX1) output 315 and a transmit 1 (TX1) input 320.

The receive path 245 may comprise a low noise amplifier 1, 325 coupled to a receiver 1, 330 coupled to an analog-to-digital converter (ADC) 1, 335. The receive path 245 may further comprise a plurality of variable delays 340(1-3) coupled to a plurality of despreaders 1a, 1b, 1c, 345(1-3). The receive path 245 may also include a dispreading code generator 1, 347 coupled to multiple variable delays 340 including the variable delay 340(2). To demodulate and optimally combine the received signals, the sector 1 antenna 305 in the receive path 245 includes demodulation and optimal combining circuitry 350, which outputs demodulated received data from sector 1. As depicted in FIG. 3, other sector 2, 3 (shown) and 4, 5, 6 (not shown) antennas may include a substantially similar circuitry as described with respect to the sector 1 antenna 305 without deviating from scope of the present invention.

TABLE I
a six-sector base station with 120° nominal beamwidth
(for the six sectors, 60°/Sector, 60° in the total overlap case)

| Sector | Minimum Angle | Boresight | Maximum Angle |
|---|---|---|---|
| 1 | 300° | 0° | 60° |
| 2 | 0° | 60° | 120° |
| 3 | 60° | 120° | 180° |
| 4 | 120° | 180° | 240° |
| 5 | 180° | 240° | 300° |
| 6 | 240° | 300° | 0° |

Table I shows an antenna configuration that employs the six antenna's 130 (1-6) (and associated co-axial feeders 235) of 120° nominal beamwidth. The boresight direction of each antenna may lead to six antennas of 120° beamwidth, arranged in a circular pattern (i.e., boresight: 0°, 60°, 120°, 180°, 240°, and 300°). In this manner, FIG. 3 may enable a receive architecture that is optimized for use with the antenna configuration shown in Table I. That is, instead of employing a diversity antenna pair that both cover 300° to 60°, sector 1 of FIG. 3/Table I, employs the three antennas from sector 6 (240° to 0°), sector 1 (300° to 60°) and sector 2 (0° to 120°). For an insignificant increase in complexity, the two antenna's may cover 300° to 60°, half of antenna 130(6) (300° to 0°) and antenna 130(1) (300° to 60°) and half of antenna 130(2) (0° to 60°) while providing an improved coverage for a minimal extra cost from the other half of antenna 130(6) (240° to 300°) and the other half of antenna 130(2) (60° to 120°).

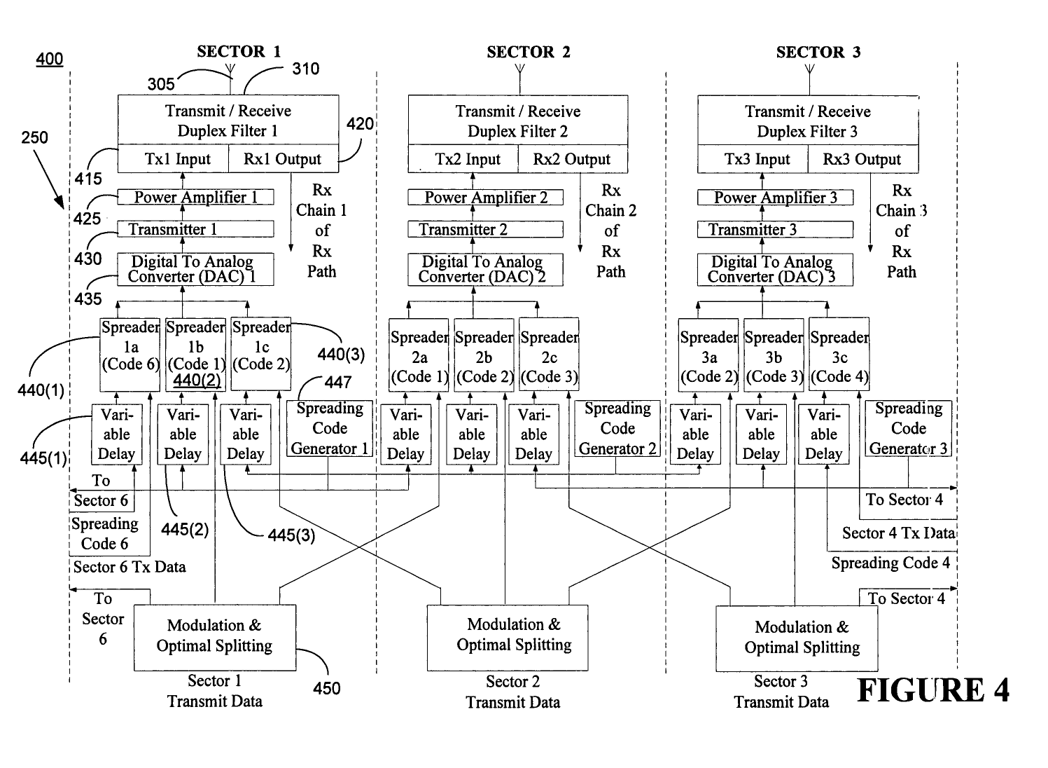

Referring to FIG. 4, a six-sector CDMA cellular base station with transmit paths 400 is shown to include the sector 1 antenna 305 that comprises the transmit path 250 shown in FIG. 2 according to one embodiment of the instant invention. The transmit path 250 of the sector 1 antenna 305 includes the transmit/receive duplex filter 1, 310, a transmit 1 (TX1) input 415 and a receive 1 (RX1) output 420. The transmit path 250 further includes a power amplifier 1, 425, a transmitter 1, 430, and a digital-to-analog converter (DAC) 1, 435. The transmit path 250 additionally may comprise a plurality of spreaders 1a, 1b, 1c, 440(1-3) coupled to a plurality of variable delays 445(1-3). Moreover, the transmit path 250 may also include a spreading code generator 1, 447 coupled to multiple variable delays including the variable delay 445(2). Besides the spreading code generator 1, 447, the transmit path 250 may include modulation and optimal splitting circuitry 450 that modulates and splits a single transmit signal received at the sector 1 antenna 305, providing sector 1 transmit data.

By optimal combining of the demodulated data, the signal-to-noise ratio (SNR) and the bit error rate (BER) of the single received signal may be improved when implementing the beam forming in order to null out an interfering signal within a sector. Similar benefits may be gained on the transmit path 250(1) by employing broadly the same architecture in the transmit chain 260 as in the receive chain 255. FIG. 4/Table I allows the sector 1 transmit signal to be optimally split between antennas 130(6), 130(1) and 130(2), in order to maintain a desired SNR/BER at a user equipment, e.g., the mobile device 115.

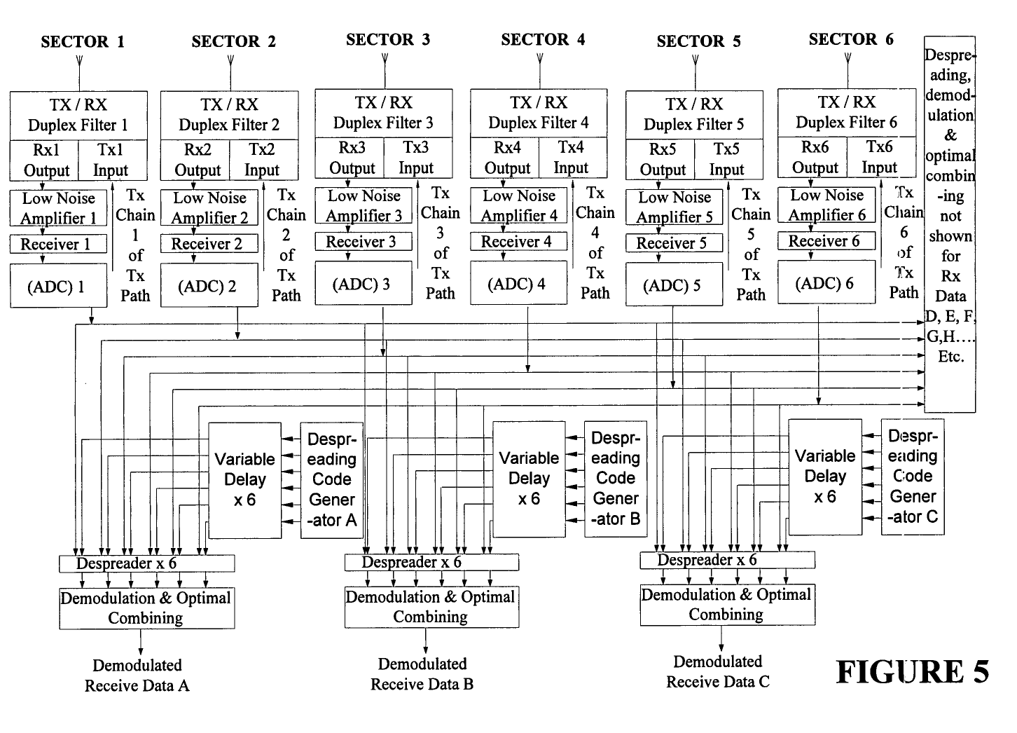

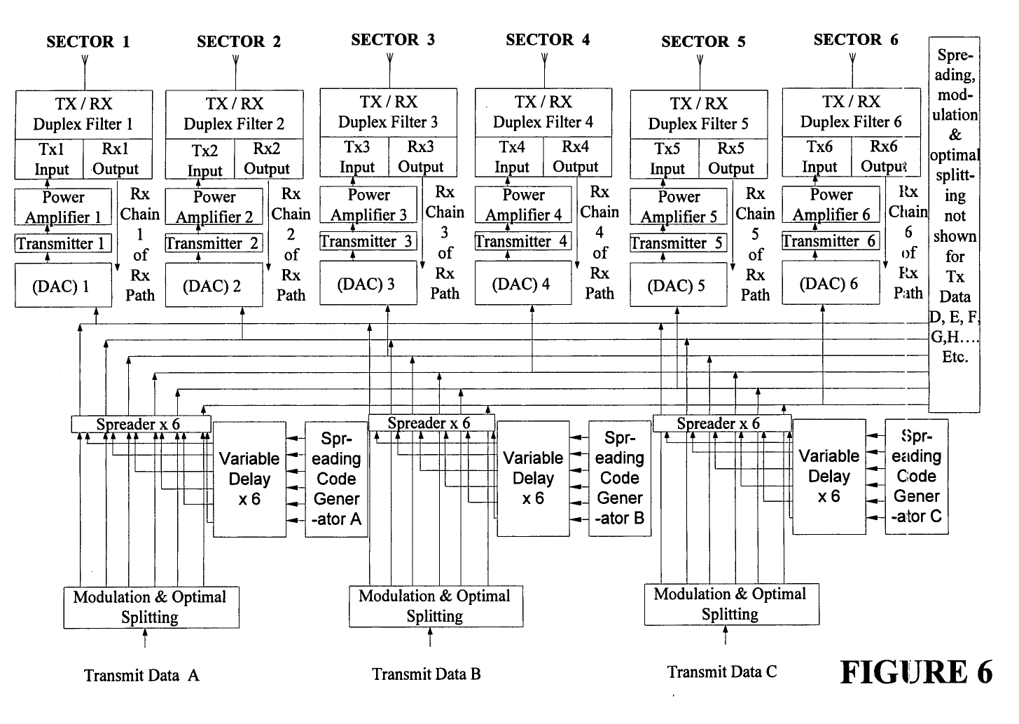

Turning now to FIG. 5 which illustrates a six-sector CDMA cellular base station showing receive paths while utilizing all sector receive paths for a received diversity and a beam forming in accordance with one illustrative embodiment of the present invention. FIG. 6 illustrates a six-sector CDMA cellular base station showing transmit paths while utilizing all sector transmit paths for a transmit diversity and a beam forming according to one embodiment of the present invention. Circuitry substantially similar to indicated above in the context of FIGS. 3 and 4 may be deployed to implement the six-sector CDMA cellular base station receive paths shown in FIG. 5 and the six-sector CDMA cellular base station transmit paths shown in FIG. 6, in an exemplary embodiment of the instant invention. Therefore, for the purposes of brevity, details of FIGS. 5 and 6, although shown such that a person of an ordinary skill in art will recognize various components of the six-sector CDMA cellular base station transmit and receive paths, are not described again.

Accordingly, FIGS. 5 and 6 show an embodiment of the instant invention covering all the sectors of the base transceiver station 220. Thus, the mobile device 115 may no longer be confined to any particular sector. In one embodiment, the optimal combining (receive) and optimal splitting (transmit) may employ all of the antennas 130(1-6) in the base transceiver station 220 in order to maintain an optimum uplink/downlink SNR/BER between the mobile device 115 and the base transceiver station 220 while minimizing the transmit powers at both ends of the link. Therefore, while the receive sensitivity may be increased, the transmit power requirement may be decreased.

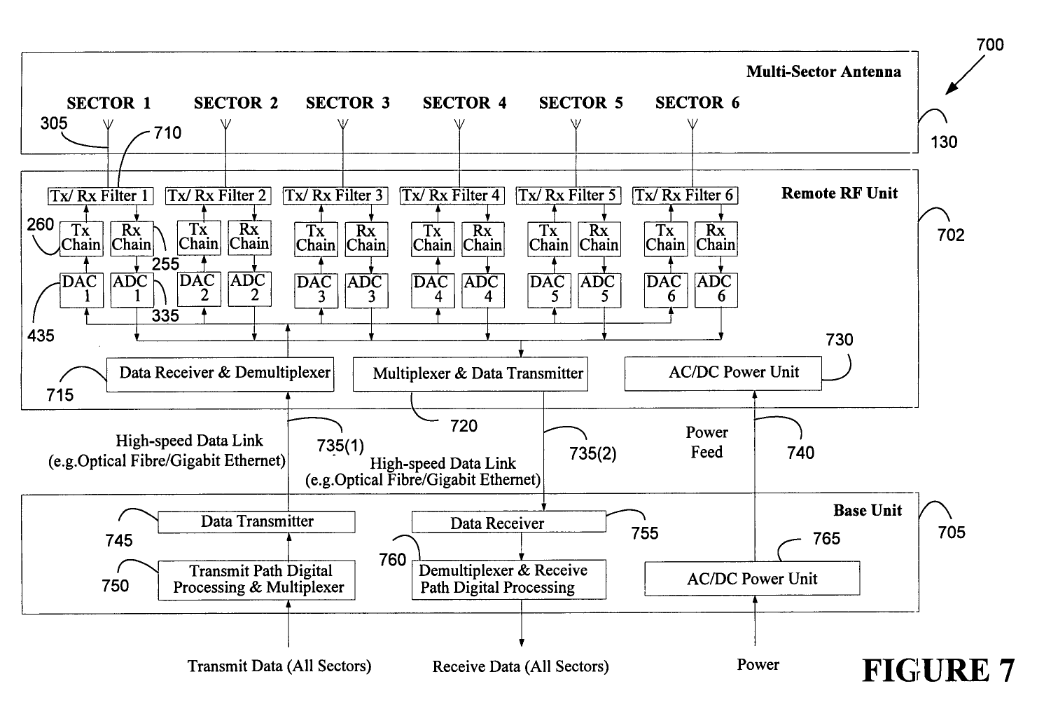

Referring to FIG. 7, a six-sector CDMA cellular base station based on a remote radio frequency architecture 700 is shown according to one illustrative embodiment of the present invention. The six-sector CDMA cellular base station architecture 700 comprises the multi-sector antenna 130 and a remote radio frequency (RF) unit 702 to which a base unit 705 is coupled. The multi-sector antenna 130 may include the sector 1 antenna 305 coupled to a transmitter/receiver (TX/RX) filter 1, 710 within the remote RF unit 702. The TX/RX filter 1, 710 may be coupled to the TX chain 260 and the RX chain 255 shown in FIG. 2.

While the digital-to-analog converter (DAC) 1, 435 may be coupled to the TX chain 260, the analog-to-digital (ADC) 1, 335 may be coupled to the RX chain 255 for the sector 1 antenna 305 within the remote RF unit 702. Additionally, a data receiver and demultiplexer 715 may be coupled to the digital-to-analog 1, 435 and a multiplexer and data transmitter 720 may be coupled to the analog-to-digital converter 1, 335. The remote RF unit 702 may further include an alternating current/direct current (AC/DC) power unit 730.

Using a plurality of high-speed data links 735(1-2), the remote RF unit 702 may communicate with the base unit 705. The base unit 705 may comprise a data transmitter 745 coupled to the data receiver and demultiplexer 715 via the high-speed data link 735(1). The base unit 705 may further comprise a data receiver 755 coupled to the multiplexer and data transmitter 720 of the remote RF unit 702 via the high-speed data link 735(2).

The base unit 705 may further include transmit path digital processing and multiplexer circuitry 750 coupled to the data transmitter 745 to receive transmit data for all the sectors. Likewise, the base unit 705 may further include demultiplexer and receive path digital processing circuitry 760 coupled to the data receiver 755 to receive data for all sectors. The base unit 705 may also include an AC/DC power unit 765 to receive power, and in turn, provide a power feed 740 to the AC/DC power unit 730 located within the remote RF unit 702.

As set forth above, in one embodiment, FIG. 7 shows the remote RF head unit 702 in which a relatively large number of antennas may be deployed, e.g. with 18 antennas, each sector may only be of 20° nominal beamwidth. In cases such as this, a single antenna in the multi-sector antenna 130 array may cover several nominal sectors, allowing a complex beam forming of the transmitted/received signals to be performed. The remote RF head unit 702 may be either integrated with a multi-sector antenna unit, separate from the multi-sector antenna unit, or may utilise multiple discrete antennas. The multi-sector antenna 130 may be a pre-assembled unit, requiring ideally no alignment during installation.

In some embodiments, by defining an optimum number of sectors or associated nominal antenna beamwidth, the base transceiver station 220 with the multi-sector antenna 130 may allow an improved receiver performance and a significantly reduced transmit power requirement. In other embodiments, with the use of the baseband digital processing circuitry 230 in the base transceiver station 220 allied with the base station architecture shown in FIG. 3-7, an improved RF performance may be obtained for no significant increase in the complexity of the radio frequency processing circuitry 225 of the base transceiver station 220 because the base station antennas 130 (1-6) are no longer in diversity pairs and are equally distributed in a circular manner.

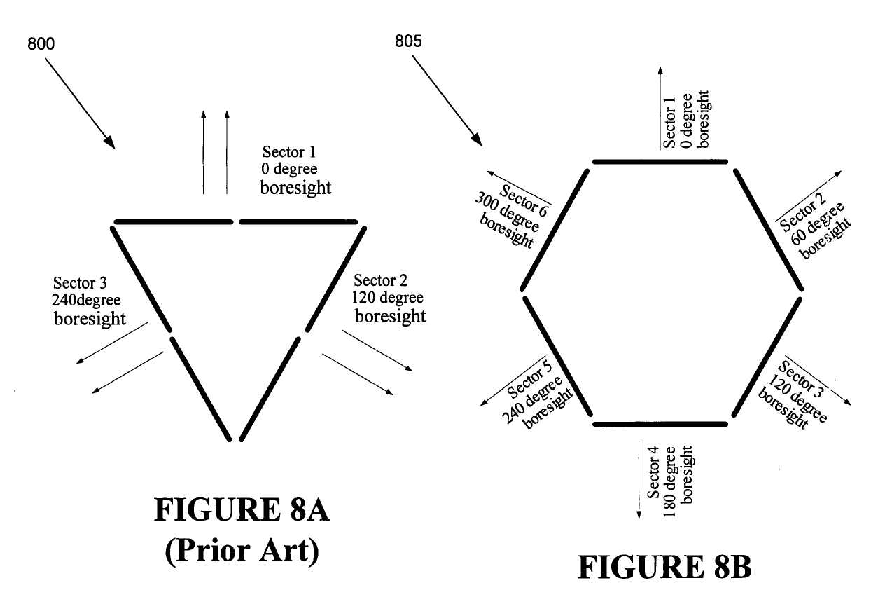

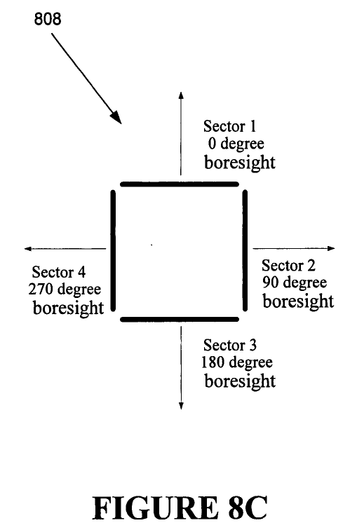

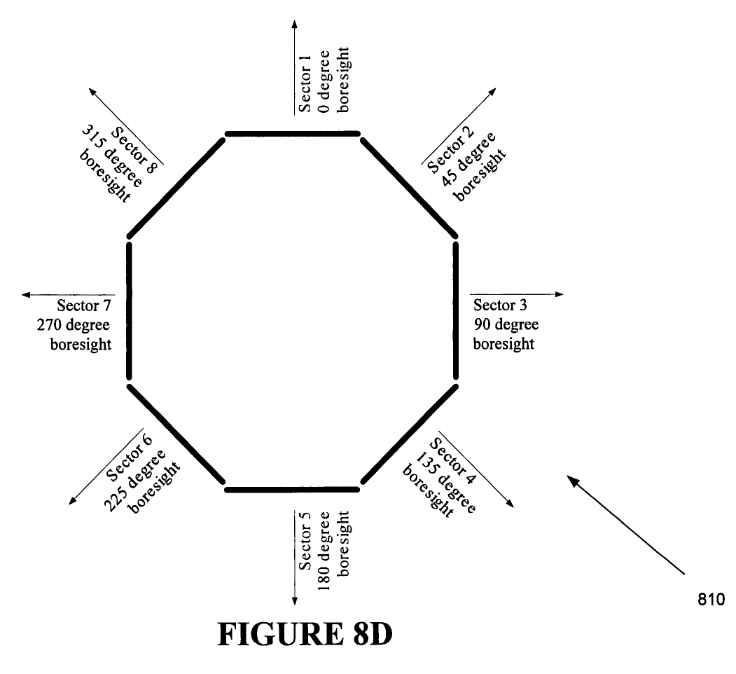

Referring to FIG. 8B, a six-sector antenna 805 may comprise a plurality of sectors 1-6 according to one embodiment of the present invention. In one embodiment, all the sectors 1-6 may have a vertical polarization (i.e., V, V, V, V, V, V). Alternatively, in another embodiment, all the sectors 1-6 may have a slant polarization in the adjacent sectors (i.e., +45°, −45°, +45°, −45°, +45°, −45°). The six-sector antenna 805 may have a beamwidth of 90 degree, (i.e., 60° for a no overlap case, 120° for a total overlap case, greater than 120° for a multi-sector overlap case). FIG. 8B illustrates an antenna configuration that may be deployed for the six-sector antenna 805 in a single radome, reducing installation and alignment costs.

Referring to FIG. 8C, a four-sector antenna 808 may include sectors 1-4 in accordance with one embodiment of the present invention. In one embodiment, all the sectors 1-4 may have a vertical polarization (i.e., V, V, V, V). Alternatively, in another embodiment, all the sectors 1-4 may have a slant polarization in the adjacent sectors (i.e., +45°, −45°, +45°, −45°). The four-sector antenna 808 may have a beamwidth of 120 degrees (90° for a no overlap case, 180° for a total overlap case, greater than 180° for a multi-sector overlap case).

As illustrated above, FIG. 8C shows an example of the multi-sector antenna 130 in a single radome. The antennas 130 (1-6) for the adjacent sectors may either use a vertical polarisation, or alternatively, a slant polarisation (e.g., +45°, −45°, +45° etc.). The slant polarisation for the antennas 130 (1-6) may cover an even number of sectors, however, offers a degree of isolation between the adjacent antennas in the single radome, allowing a smaller package size. The slant polarisation also offers a degree of polarisation diversity between physically close antennas. Installing the multi-sector antenna 130 in a single package may reduce the amount of alignment required during installation to almost negligible.

Referring to FIG. 8D, an eight-sector antenna 810 may comprise a plurality of sector antennas 1-8 according to one illustrative embodiment of the present invention. Consistent with one embodiment, all the sectors 1-8 may have a vertical polarization (i.e., V, V, V, V, V, V, V, V). In other embodiments, a slant polarization may be provided in the adjacent sectors (i.e., +45°, −45°, +45°, −45°, +45°, −45°, +45°, −45°). The eight-sector antenna 810 may have a beamwidth of 67.5 degrees, (i.e., 45° for a no overlap case, 90° for a total overlap case, greater than 90° for a multi-sector overlap case).

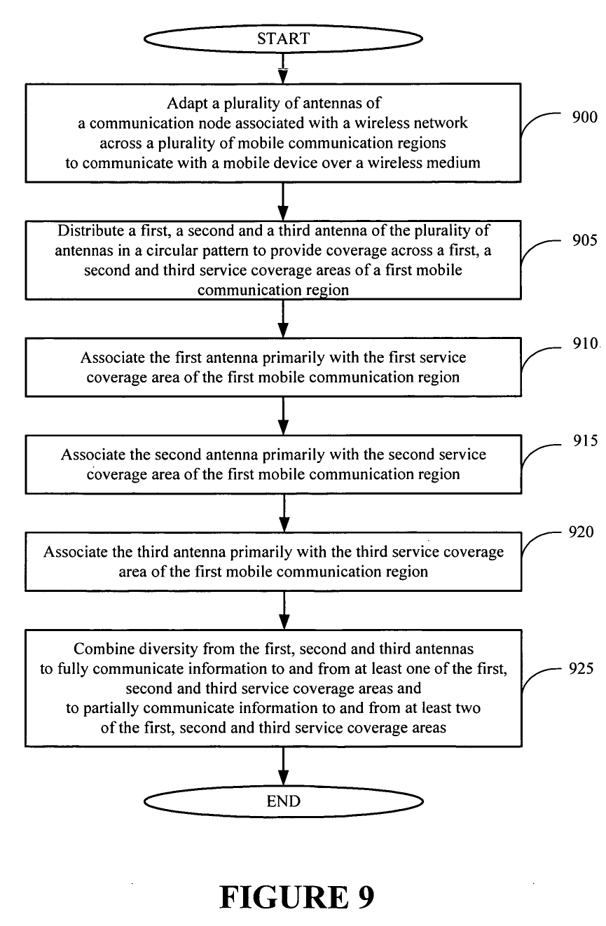

Turning to FIG. 9, a stylized representation of a method for controlling wireless communications from the multi-sector antenna 130 of the base transceiver station 220 is depicted in accordance with one illustrative embodiment of the present invention. At block 900, the base transceiver station 220, for example, for the communication node 105 may adapt the plurality of antennas 130(1-6) associated with the wireless network 110 across the plurality of mobile communication regions including the first mobile communication region 125 to communicate with the mobile device 115 over the wireless medium 120.

At block 905, the first and second antennas 130(1-2) may be distributed in a circular pattern to communicate information to and from at least one of the first and second service coverage areas 135(1-2). At block 910, the communication node 105 may configure the first antenna 130(1) of the plurality of antennas 130(1-6) to keep a majority of communication coverage within the first service coverage area 135(1) of the first mobile communication region 125. At block 915, the communication node 105 may configure the second antenna 130(2) to communicate over at least a portion of the second service coverage area 135(2) of the first mobile communication region 125.

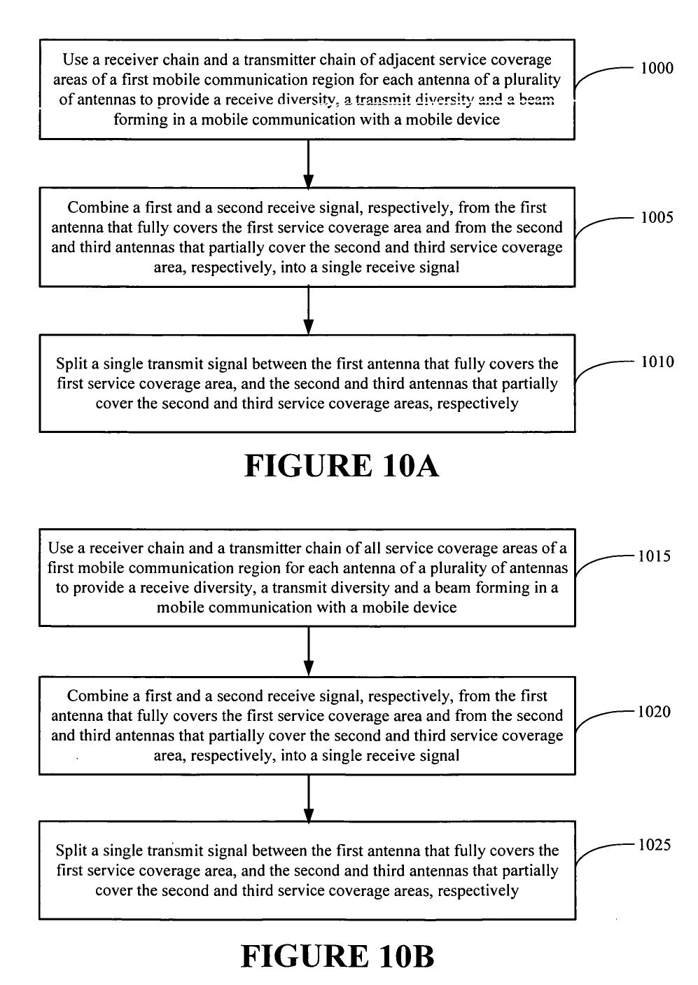

Referring to FIG. 10A, a stylized representation of a method that uses the receiver (RX) chain 255 and the transmitter (TX) chain 260 of adjacent service coverage areas of the first mobile communication region 125 for each antenna of the plurality of antennas 130(1-6) is shown to provide a receive diversity, a transmit diversity and a beam forming in a mobile communication with the mobile device 115, according to one illustrative embodiment of the present invention. At block 1000, the RX chain 255 and the TX chain 260 of the adjacent service coverage areas may be used according to the six-sector CDMA cellular base station shown in FIGS. 3-7.

At block 1005, receive signals from the first and second antennas 130(1-2) that cover the first and second service coverage areas 135(1-2) of the first mobile communication region 125, respectively, may be combined into a single receive signal. Likewise, at block 1010, a single transmit signal may be split between the first and second antennas 130(1-2) covering the first and second service coverage areas 135(1-2), respectively.

Referring to FIG. 10B, a stylized representation of a method that uses the RX chain 255 and the TX chain 260 of all the service coverage areas 135 of the first mobile communication region 125 for each antenna of the plurality of antennas 130(1-6) is depicted to provide a receive diversity, a transmit diversity and a beam forming in a mobile communication with the mobile device 115 according to one exemplary embodiment of the instant invention. At block 1015, the RX chain 255 and the TX chain 260 of all the service coverage areas 135 of the first mobile communication region 125 shown in FIG. 1 may be used for each antenna of the plurality of antennas 130(1-6).

At block 1020, receive signals from the first and second antennas 130(1-2) covering the first and second service coverage areas 135(1-2) of the first mobile communication region 125, respectively, may be combined into a single receive signal. Likewise, at block 1025, a single transmit signal may be split between the first and second antennas 130(1-2) covering the first and second service coverage areas 135(1-2), respectively.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A communication node associated with a wireless network, said communication node to communicate with a mobile device over a wireless medium across a plurality of mobile communication regions, said communication node comprising:
an antenna arrangement including a first, a second and a third antenna, wherein said first antenna is primarily associated with a first service coverage area of a first mobile communication region of said plurality of mobile communication regions, said second antenna is primarily associated with a second service coverage area of said first mobile communication region, and said third antenna is primarily associated with a third service coverage area of said first mobile communication region for combining diversity from said first, second and third antennas to fully communicate information to and from at least one of said first, second and third service coverage areas and to partially communicate information to and from at least two of said first, second and third service coverage areas.

2. A communication node, as set forth in claim 1, wherein said antenna arrangement further comprising:
an antenna configuration in which said plurality of antennas is arranged in a circular pattern and said mobile device is not confined to any particular service coverage area of said first and second service coverage areas.

3. A communication node, as set forth in claim 2, wherein said antenna arrangement further comprising:
a plurality of co-axial feeders associated with said plurality of antennas; and
a tower with a top and a base for each antenna of said plurality of antennas.

4. A communication node, as set forth in claim 3, wherein said antenna arrangement further comprising:
a plurality of radio frequency filters; and
baseband digital processing circuitry disposed at the base of the tower.

5. A communication node, as set forth in claim 1, wherein said antenna arrangement further comprising:
a receive path including a receiver chain for each antenna of said plurality of antennas, wherein said receiver chains of the adjacent service coverage areas to provide a receive diversity and a beam forming in a mobile communication with said mobile device.

6. A communication node, as set forth in claim 1, further comprising:
a transmit path including a transmitter chain for each antenna of said plurality of antennas, wherein said transmitter paths of the adjacent service coverage areas to provide a transmit diversity and a beam forming in a mobile communication with said mobile device.

7. A communication node, as set forth in claim 1, further comprising:
a receive path including a receiver chain for each antenna of said plurality of antennas, wherein said receiver chains of all the service coverage areas of said first mobile communication region to provide a receive diversity and a beam forming in a mobile communication with said mobile device.

8. A communication node, as set forth in claim 1, further comprising:
a transmit path including a transmitter chain for each antenna of said plurality of antennas, wherein said transmitter paths of all the service coverage areas to provide a transmit diversity and a beam forming in a mobile communication with said mobile device.

9. A communication node, as set forth in claim 1, further comprising:
a digital combiner to combine a first and a second receive signal, respectively, from said first antenna that fully covers said first service coverage area and from said second and third antennas that partially cover said second and third service coverage areas, respectively, into a single receive signal.

10. A communication node, as set forth in claim 1, further comprising:
a digital splitter to split a single transmit signal between said first antenna that fully covers said first service coverage area, and said second and third antennas that partially cover said second and third service coverage areas, respectively.

11. A base station associated with a plurality of cells for transmitting and receiving communication information to and from a mobile device, each said cell being divided into a plurality of sectors, the base station comprising:
a multi-sector antenna arrangement including a first, a second and a third antenna, wherein for combining diversity from said first, second and third antennas said first antenna is configured to provide a full coverage in a first sector of said cell of said plurality of cells and said second and third antennas are configured to provide a partial coverage in at least one of a second and a third sector of said cell of said plurality of cells such that said base station adapts said first antenna to radiate a first beam in said first sector of said cell to provide said full coverage in said first sector and adapts said second and third antennas to radiate a second and a third beam, respectively, that provide said partial coverage in said second and third sectors of said cell.

12. A base station, as set forth in claim 11, wherein said first sector is adjacent to said second sector.

13. A base station, as set forth in claim 11, wherein said first antenna to receive a first signal from said mobile device and said second antenna to receive a second signal from said mobile device.

14. A base station, as set forth in claim 11, wherein said multi-sector antenna arrangement includes a set of sector antennas such that a receive path of the adjacent sector antennas provide a receive diversity and a beam forming in a mobile communication with said mobile device.

15. A base station, as set forth in claim 11, wherein said multi-sector antenna arrangement includes a set of sector antennas such that a transmit path of the adjacent sector antennas provide a transmit diversity and a beam forming in a mobile communication with said mobile device.

16. A base station, as set forth in claim 11, wherein said multi-sector antenna arrangement includes a set of sector antennas such that a receive path of all the sector antennas provide a receive diversity and a beam forming in a mobile communication with said mobile device.

17. A base station, as set forth in claim 11, wherein said multi-sector antenna arrangement includes a set of sector antennas such that a transmit path of all the sector antennas provide a transmit diversity and a beam forming in a mobile communication with said mobile device.

18. A base station, as set forth in claim 11, further comprising:
a digital combiner to combine a first and a second receive signal, respectively, from said first antenna that fully covers said first sector of said cell and from said second and third antennas that partially cover said second and third sectors of said cell, respectively, into a single receive signal; and
a digital splitter to split a single transmit signal between said first antenna that fully covers said first sector of said cell, and said second and third antennas that partially cover said second and third sectors of said cell, respectively.

19. A base station, as set forth in claim 11, wherein said first, second and third antennas to provide coverage within a nominal bandwidth across said first, second and third sectors of said cell.

20. A base station, as set forth in claim 11, further comprising:
a tower with a top and a base for substantially equally distributing said plurality of antennas in a circular manner in said multi-sector antenna arrangement;
a radio frequency unit coupled to the tower for radio frequency processing of the communication information; and
a base unit coupled to the tower for baseband digital processing of the communication information.

21. A digital cellular network, comprising:
a plurality of cells to communicate with a mobile device over a wireless medium, wherein at least one of said plurality of cells to include a base transceiver station having a base station for transmitting and receiving communication information, the base station including:
a multi-sector antenna arrangement including a first, a second and a third antenna, wherein for combining diversity from said first, second and third antennas said first antenna is configured to provide a full coverage in a first sector of said cell of said plurality of cells and said second and third antennas are configured to provide a partial coverage in at least one of a second and a third sector of said cell of said plurality of cells such that said base station adapts said first antenna to radiate a first beam in said first sector of said cell to provide said full coverage in said first sector and adapts said second and third antennas to radiate a second and a third beam, respectively, that provide said partial coverage in said second and third sectors of said cell.

22. A digital cellular network, as set forth in claim 21, wherein the base station is defined least in part by a Code Division Multiple Access protocol and said multi-sector antenna arrangement is disposed in a single radome.

23. A digital cellular network, as set forth in claim 21, wherein the base station further comprises:
modulation and demodulation circuitry that increases a receive sensitivity and decreases a transmit power requirement of said base transceiver station using said multi-sector antenna arrangement for a receive diversity, a transmit diversity and a beam forming in a mobile communication with said mobile device.

24. A telecommunication system, comprising:
a communication node associated with a wireless network, said communication node to communicate with a mobile device over a wireless medium across a plurality of mobile communication regions, said communication node including:
an antenna arrangement including a first, a second and a third antenna, wherein said first antenna is primarily associated with a first service coverage area of a first mobile communication region of said plurality of mobile communication regions, said second antenna is primarily associated with a second service coverage area of said first mobile communication region, and said third antenna is primarily associated with a third service coverage area of said first mobile communication region for combining diversity from said first, second and third antennas to fully communicate information to and from at least one of said first, second and third service coverage areas and to partially communicate information to and from at least two of said first, second and third service coverage areas.

25. A telecommunication system, as set forth in claim 24, wherein said communication node is defined at least in part by a Code Division Multiple Access protocol and said antenna arrangement is disposed in a single radome.

26. A telecommunication system, as set forth in claim 24, wherein said antenna arrangement to provide a receive diversity, a transmit diversity and a beam forming in a mobile communication with said mobile device.

27. A method of adapting a plurality of antennas of a communication node associated with a wireless network across a plurality of mobile communication regions to communicate with a mobile device over a wireless medium, the method comprising:
distributing a first, a second and a third antenna of said plurality of antennas in a circular pattern to provide coverage across a first, a second and third service coverage areas of a first mobile communication region of said plurality of mobile communication regions;
associating said first antenna primarily with said first service coverage area of said first mobile communication region;
associating said second antenna primarily with said second service coverage area of said first mobile communication region;
associating said third antenna primarily with said third service coverage area of said first mobile communication region; and
combining diversity from said first, second and third antennas to fully communicate information to and from at least one of said first, second and third service coverage areas and to partially communicate information to and from at least two of said first, second and third service coverage areas.

28. A method, as set forth in claim 27, further comprising:
using a receiver chain and a transmitter chain of the adjacent service coverage areas of said first mobile communication region for each antenna of said plurality of antennas to provide a receive diversity, a transmit diversity and a beam forming in a mobile communication with said mobile device.

29. A method, as set forth in claim 27, further comprising:
using a receiver chain and a transmitter chain of all the service coverage areas of said first mobile communication region for each antenna of said plurality of antennas to provide a receive diversity, a transmit diversity and a beam forming in a mobile communication with said mobile device.

30. A method, as set forth in claim 27, further comprising:
combining a first and a second receive signal, respectively, from said first antenna that fully covers said first service coverage area and from said second and third antennas that partially cover said second and third service coverage areas, respectively, into a single receive signal; and
splitting a single transmit signal between said first antenna that fully covers said first service coverage area, and said second and third antennas that partially cover said second and third service coverage areas, respectively.

31. An antenna arrangement for a communication node associated with a wireless network to communicate with a mobile device over a wireless medium across a plurality of mobile communication regions, said antenna arrangement comprising:
a first, a second and a third antenna, wherein said first antenna is primarily associated with a first service coverage area of a first mobile communication region of said plurality of mobile communication regions, said second antenna is primarily associated with a second service coverage area of said first mobile communication region, and said third antenna is primarily associated with a third service coverage area of said first mobile communication region for combining diversity from said first, second and third antennas to fully communicate information to and from at least one of said first, second and third service coverage areas and to partially communicate information to and from at least two of said first, second and third service coverage areas.

32. An antenna arrangement, as set forth in claim 31, wherein said first antenna provides a full coverage of said first service coverage area, said second antenna provides at least a partial coverage of said first service coverage area and said third antenna provides at least a partial coverage of said first service coverage area.

33. An antenna arrangement, as set forth in claim 31, wherein said first antenna provides at least a partial coverage to said second and third service coverage areas.

34. An antenna arrangement, as set forth in claim 31, wherein said communication node includes a cellular base station to use each antenna of said first second and third antennas for covering either adjacent sectors or all sectors of a cell in a telecommunication system.

35. An antenna arrangement, as set forth in claim 31, wherein each of said first, second, and third antennas are configured to coordinate reception of a receive signal and transmission of a transmit signal such that said communication node to adapt said first second, and third antennas to provide coverage selectively across said first, second and third service coverage areas in a full or partial manner.
